(19) United States
(12) Patent Application Publication
(10) Pub. No.: US 2019/0035266 A1
(43) Pub. Date: Jan. 31, 2019

(54) SYSTEMS AND METHODS FOR ROAD USER CLASSIFICATION, POSITION, AND KINEMATIC PARAMETER MEASURING AND REPORTING VIA A DIGITAL TELECOMMUNICATION NETWORK

(71) Applicant: GM GLOBAL TECHNOLOGY OPERATIONS LLC, Detroit, MI (US)

(72) Inventors: Eilon Riess, ZIKRON-YAAKOV (IL); Efrat Rosenman, ZIKRON-YAAKOV (IL)

(73) Assignee: GM GLOBAL TECHNOLOGY OPERATIONS LLC, Detroit, MI (US)

(21) Appl. No.: 15/660,445

(22) Filed: Jul. 26, 2017

(51) Int. Cl. G08G 1/01; G08G 1/017; G08G 1/052; G05D 1/02; G05D 1/00

(52) U.S. Cl. CPC G08G 1/0141; G08G 1/0112; G05D 1/0088; G08G 1/052; G05D 1/0285; G08G 1/017

(57) ABSTRACT

A method for road user position report includes the steps of receiving, at a remotely located server, a digital, electronic report from a mobile device that comprises a user classification, a user geographical position, and at least one user kinetic parameter, such as a speed vector, and providing the report, from the server, to a human-operated or autonomously-controlled vehicle. The steps of receiving and providing are performed automatically and without human intervention using a telecommunication network. Road users not relevant to the vehicle are filtered-out and not provided to the vehicle.

The present disclosure generally relates to systems and methods operating on a digital telecommunication network. More particularly, the present disclosure relates to systems and methods for road user classification, position, and kinematic parameter measuring and reporting via a digital telecommunication network.

Traditional telecommunication, e.g. by cellular phones and similar devices, was based on circuit switching, in which a communications channel is opened to connect two communicating devices. More advanced telecommunication devices (sometimes referred to as fourth generation, or 4G, devices) may be based on packet switching. In contrast with circuit switching, in packet switching no dedicated communications channel is opened between the devices. Rather, information to be communicated is organized in the form of addressable data packets. The packets may be routed over a digital telecommunication network in a manner similar to network communications among computers.

Modern telecommunication systems that are based on packet switching may enable introduction of applications and features that were not as readily available under circuit switching. Such applications may include position and kinematic parameter monitoring, which include for example direction of movement, velocity, acceleration, and the like. The packets may also be able to include information regarding a classification of the user associated with the mobile device, such as for example whether the user may be associated with a vehicle (and if so, what type of vehicle), with a bicycle, as a pedestrian, etc. The integration of Global Positioning System (GPS) receivers into mobile terminals has become common, and may even be considered to be a standard feature that is expected from a mobile phone. The monitored position may be reported on a regular basis to an application that extracts useful information from reported positions of a community of users. For example, such an application may analyze vehicular, bicycle, and/or pedestrian traffic patterns. Such position information may also be utilized in operation of a network.

The operation of modern vehicles is becoming more autonomous, i.e., vehicles are able to provide driving control with less and less driver intervention. As vehicle systems improve, they will become more autonomous with the goal being a complete autonomously driven vehicle. For example, vehicles may employ autonomous systems for lane changing, passing, turns away from traffic, turns into traffic, etc. Smooth maneuvering and automated lane centering and lane changing control is important for driver and passenger comfort in autonomously driven vehicles.

An important feature in the ability to operate a vehicle autonomously is the detection and avoidance of obstacles. Of course, this ability is important for human operators of vehicles as well. While some obstacles are stationary, such as signs, buildings, parked vehicles, and the like, other obstacles are themselves moving. Such moving obstacles may include pedestrians, bicyclists, and other vehicles in traffic. Autonomous vehicles may include one or more sensors that allow the vehicle to be able to detect moving and non-moving obstacles. These sensors include radio-wave or visual-based sensors, as non-limiting examples. Yet, it may be difficult to have these sensors detect obstacles in all situations, for example in which an object remains “hidden” until shortly before they are encountered (e.g., a pedestrian or bicyclist emerging into the roadway from behind a large vehicle, a vehicle emerging from a blind driveway, and the like). Alternatively, an object may be “nomadic” in the sense that it is located in a static position for a finite period of time. Improved means for detection of these obstacles would thus improve the operation of an autonomous vehicle.

Accordingly, it would be desirable to provide systems and methods that are able to better provide autonomous vehicles with the locations of static and moving obstacles, such as pedestrians, bicyclists, and other vehicles, which are not readily detectable by conventional sensors. With the near ubiquity of persons possessing telecommunication devices that have position and other parameter measuring and reporting capabilities (for example, these device may also include an accelerometer, a compass, a barometer, etc.), it would further be desirable to leverage modern telecommunication systems in achieving this goal. Furthermore, other desirable features and characteristics of the present disclosure will become apparent from the subsequent detailed description and the appended claims, taken in conjunction with the accompanying drawings and this introductory section.

### BRIEF SUMMARY

In one embodiment, disclosed is a method for road user classification, position, and kinematic parameter measuring and reporting that includes the steps of receiving, at a remotely located server, a digital, electronic report from a mobile device that comprises a user classification, a user geographical position, and at least one user kinetic parameter, and providing the report, from the server, to an autonomously-controlled vehicle. The steps of receiving and providing are performed automatically and without human intervention using a telecommunication network.

In another embodiment, disclosed is a method for road user classification, position, and kinematic parameter measuring and reporting that includes the steps of receiving, at a remotely located server, a digital, electronic report from a mobile device that comprises a user classification, a user geographical position, and at least one user kinetic parameter, and providing the report, from the server, to human-operated vehicle. The steps of receiving and providing are performed automatically and without human intervention using a telecommunication network. The provided report may be received at the human-operated vehicle and displayed or provided to the human operator for purposes of improved situational awareness while driving.

In variations, the method may include receiving, at the remotely located server, a plurality of digital, electronic reports from a plurality of mobile devices. The method may include storing information at the server that at least one of the plurality of mobile devices is associated with a pedestrian. The method may include storing information at the server that at least one of the plurality of mobile devices is associated with a bicyclist. The method may include storing information at the server that at least one of the plurality of mobile devices is associate with a vehicle. The remotely located server may be a cloud-based server. The method may include, at the remotely located server, generating a digital mosaic map of the plurality of reports and providing the digital mosaic map to the autonomously-controlled vehicle. The method may include, at the remotely located server, receiving a subsequent digital, electronic report from a mobile device, calculating an estimated speed of travel of the mobile device based on the digital, electronic report and the subsequent digital, electronic report, and providing the estimated speed of travel, from the server, to the autonomously-controlled vehicle. The method may include providing the report, from the server, to a fleet of autonomously-controlled vehicles, all of which are located within a geographical service area. The telecommunication network may be a 4G LTE telecommunication network. The mobile device may be a smartphone, tablet computer, or computer system integrated within a vehicle. The method step of receiving may be performed on the basis of a request to send a position report generated from a computer application that is resident on the mobile device. The report is provided from the server in a format suitable for use by a control system of the human-operated or autonomously-controlled vehicle.

In another embodiment, disclosed is a computer-based server system that includes a data storage component and a processor. The data storage component includes electronic instructions that causes the processor to receive a digital, electronic report that includes a user classification, a user geographical position, and at least one user kinetic parameter, from a mobile device and provide the report to a human-operated or autonomously-controlled vehicle. The receive and provide functionalities are processed automatically and without human intervention using a telecommunication network.

In yet another embodiment, an autonomously-controlled vehicle includes an autonomous vehicle control system and a telecommunication receiving system operably coupled with the autonomous vehicle control system. The telecommunication receiving system is configured to receive, from a remotely-located server, a digital, electronic report that includes a user classification, a user geographical position, and at least one user kinetic parameter, which originated from a mobile device. Based on the report, the autonomous vehicle control system is configured to cause the autonomously-controlled vehicle to operate in a manner that avoids conflict with the mobile device.

### BRIEF DESCRIPTION OF THE DRAWINGS

The present disclosure will hereinafter be described in conjunction with the following drawing figures, wherein like numerals denote like elements, and wherein:

FIG. 1 schematically illustrates an embodiment of a system that is configured for position reporting;

FIG. 2 schematically illustrates an embodiment of a server that is configured for position reporting; and

FIG. 3 is a flowchart for a method for position reporting in accordance with an embodiment of the present disclosure.

### DETAILED DESCRIPTION

The following detailed description is merely exemplary in nature and is not intended to limit the disclosure or the application and uses of the reporting systems and methods. Furthermore, there is no intention to be bound by any theory presented in the preceding introductory section or the following detailed description.

Unless specifically stated otherwise, as apparent from the following discussions, it is appreciated that throughout the specification discussions utilizing terms such as “processing,” “computing,” “storing,” “determining,” “evaluating,” “calculating,” “measuring,” “providing,” “transferring,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with an embodiment of this disclosure, user classification, position, and kinematic parameter information may be communicated between a mobile communication device, on the one hand, and another device or server, on the other, in a manner that is determined by a communication scheme. A mobile communication device may be understood to include any device with a communication function that is configured to be moveable or transportable. A mobile communication device may include, for example, a handheld or portable device (e.g. mobile telephone, smartphone, portable computer, or similar device with communications capabilities), a vehicle-mounted device (e.g. vehicle-mounted telephone or other communications device, or an onboard computer), or other mobile device (e.g. tracking device that is carried by an animal, or by a water or air current) that is capable of communicating with a remote device at least partly over a wireless digital network. The mobile communication device may include a capability for determining a user classification associated with the mobile communication device (e.g., pedestrian, bicycle, vehicle type, etc.) position or location of the mobile communication device (or a component of the mobile communication device), and at least one kinematic parameter associated with the mobile device (such as direction, velocity, and/or acceleration of movement, etc., if any). For example, the mobile communication device may include a Global Positioning System (GPS) receiver. The mobile communication device may include processing or computing capability. A mobile communication device may be associated with a user or client of a communications service or application. The user may be in a vehicle that is moving, the user may be a bicyclist utilizing roads that are also shared by vehicular traffic, or the user may be a pedestrian crossing a roadway.

A server may be understood to include a device, or a collection of intercommunicating devices, that include capability to communicate with one or more mobile communication devices. In a preferred embodiment, the server is a cloud-based server. One or more components of the server may be fixed, or may be portable. One or more components may be co-located or distributed. For purposes of the description herein, a device may be considered to be providing functionality of a server when motion of that device is not relevant to determination of a communication scheme. A server includes processing or computing capability. A server may be associated with a provider of a communications service or application.

A communication scheme may include one or more characteristics, properties, or features of communication between the mobile communication device and the server. Such features may include, for example, an interval between successive communications of classification, position, and kinematic parameter information, a rate of communicating such information, selective communication of such information, selecting a mobile communication device from a cluster of mobile communication devices to communicate such information.

The communications scheme may be geographically limited to an area of interest. For example, with regard to a human-operated or autonomous vehicle interested in knowing the location of other vehicles, bicyclists, or pedestrians in its vicinity, classification, position, and kinematic parameter information from only those mobile devices within a certain geographical area in relation to the vehicle would be relevant. Geographic limitations may also apply to a fleet of autonomous vehicles that operate within a particular service area, such as within a particular metropolitan area. In this case, it would be desirable to only obtain information regarding mobile devices that are within the particular service area. A rate of classification, position, and kinematic parameter information communication (a frequency with which position updates are communicated) may increase when the mobile device is closer to an area of interest/vehicle, and may decrease when further away in order to reduce power consumption and saved battery life of the mobile device. This would also result in a reduction of cellular data usage, which in turn would result in a reduction of cost and network load.

As another example, a communication scheme for classification, position, and kinematic parameter information between a mobile device and a server may be affected by information regarding infrastructure. Information that is obtained regarding an infrastructure (e.g. roadway, pedestrian lane, railroad, boat lane) may be interpreted as being related to mobility of the mobile communication device. Such infrastructure information may be obtained from a sensor that is associated with the mobile communication device, or may be reported and communicated by a controller or processor that is associated with the infrastructure (e.g. directly or via a server). For example, when the mobile device is associated with a vehicle, information may be received with regard to a current status of a traffic signal or traffic sensor, or of other controls (e.g. a railroad switch, bridge position, road conditions report, or weather report). Such received information may be incorporated in a determination of communication scheme or of an interval between successive communications of the type described herein.

The communication scheme may be implemented as or in connection with a vehicle to everything (V2X) system. V2X communication is the passing of information from a vehicle to any entity that may affect the vehicle, and vice versa. It is a vehicular communication system that incorporates other more specific types of communication as V2I (Vehicle-to-Infrastructure), V2V (Vehicle-to-vehicle), V2P (Vehicle-to-Pedestrian), V2D (Vehicle-to-device), V2G (Vehicle-to-grid), V2B (Vehicle-to-bicycle), and V2M (Vehicle-to-motorbike).

In some embodiments, communication of classification, position, and kinematic parameter information may be based on packet switching communication. With packet switching, use of a mobile communication device may be monitored for a quantity of data (e.g. number of data packets) that is sent by the mobile communication device. A subscriber to service that includes such reporting may be billed or charged in accordance with the monitored quantity of transmitted or reported data. Thus, a communication scheme that reduces the quantity of transmitted position data may result in savings for a user of the mobile communication device without reducing the accuracy of the reported classification, position, and kinematic parameter. Thus, in some embodiments, the packet may be limited only to a device identification code, a time stamp, a position, and a kinematic parameter, for example. As noted above, the frequency of packet sending may be reduced or increased based on certain factors, such as geographic location and proximity.

Some or all of reported classification, position, and kinematic parameter data may be saved temporarily or permanently by a server that receives the data. For example, the received data may be saved on one or more memory or data storage units or devices that are associated with the server. A communications scheme that reduces the quantity of received classification, position, and kinematic parameter data may enable the server to efficiently utilize available data storage resources.

With regard to classification, a user's mobile device may be specifically associated with a form of transportation. For example, a particular mobile device may be associated with a user who typically acts as a pedestrian, as a bicyclist, or as a vehicle operating. This information may be saved at the server that receives the data. Accordingly, in some embodiments, a mobile device report may be associated with a particular form of travel (classification) without the need for this information to be repeatedly transmitted in the data packet.

A mobile device may have downloaded thereto a particular computer application or “app” that provides the location reporting functionality. For example, in some instances, a user may be incentivized to download the application when within a particular geographic area. In another example, the application may automatically be downloaded as a condition of the user utilizing a particular mobile network connection. In any case, the app may be configured such that the user's personal information is kept secure, while only transmitting location data to the server, at a time interval as desired.

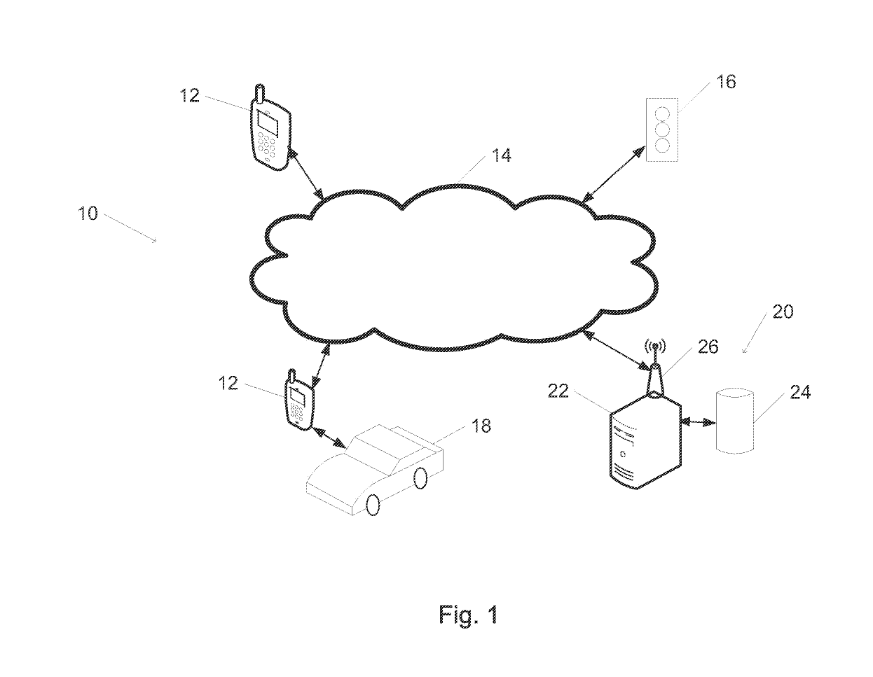

With reference now to FIG. 1, reporting system 10 is configured for classification, position, and kinematic parameter measuring and reporting by one or more mobile communication devices 12. Each mobile communication device 12 is configured to communicate at least with a server 20 via a network 14. The server 20 may be a cloud-based server. A mobile communication device 12 may include a portable or transportable device that is capable of reporting a classification, position (location), and at least one kinematic parameter (direction, velocity, acceleration) of mobile communication device 12. For example, a mobile communication device 12 may be provided with a GPS receiver. As another example, a mobile communication device 12 may be capable of determining its position and/or rate of movement in relation to fixed objects (e.g. antennas). Mobile communication device 12 may include, for example, a mobile telephone, a smartphone, a portable or handheld computer, a vehicle's onboard computer, a GPS device, or any other device that is transportable from one location to another and that is provided with capability to determine and report its classification, position (e.g. geographical coordinates in one or more directions), and at least one kinematic parameter (e.g. rate and direction of movement with respect to such geographical coordinates). For a previously-defined and known geographical area, the geographical coordinates may be truncated to reduce data load.

Reporting system 10 may be limited to those mobile communication devices 12 that are registered or otherwise indicated as being included within reporting system 10. For example, the mobile communication device 12, a user of mobile communication device 12, or a vehicle with which mobile communication device 12 is associated, may subscribe to a reporting service that is associated with reporting system 10.

Mobile communication device 12 may include processing capability for performing in accordance with programmed instructions. In other cases, mobile communication device 12 may be provided with minimal processing capability. In such a case, processing that is associated with mobile communication device 12 may be performed by one or more remote processors. A remote processor may include, for example, a processor of another mobile communication device 12, or of a server 20.

Network 14 may include any network that enables communication between mobile communication device 12 and one or more remote devices or systems. The remote devices may include another mobile communication device 12, a server 20, or an infrastructure-related device or system such as infrastructure device 16. Network 14 may include a wired or wireless network. For example, in a case that mobile communication device 12 is freely transportable, network 14 may include a wireless component. In other examples, mobile communication device 12 may be constrained to movement along predetermined lanes or tracks (e.g. when mobile communication device 12 is transported by a railroad, trolley, or cable car). In such a case, network 14 need not, but may, include a wireless component. Network 14 may represent two or more separate networks. For example, one of the separate networks may enable communication between mobile communication device 12 and server 20. Another separate network may enable communication between infrastructure device 16 and server 20.

A mobile communication device 12 may be associated with, or transported by, a vehicle 18, wherein the vehicle may include a vehicle control system. For example, mobile communication device 12 may be associated with a passenger of vehicle 18. Mobile communication device 12 may be associated with a driver or operator of vehicle 18. For example, mobile communication device 12 may include a personal smartphone or portable computer of the passenger, driver, or operator. In another example, mobile communication device 12 may include an onboard computer, GPS device, or communications device that is incorporated into vehicle 18. Mobile communication device 12 may represent two or more intercommunicating devices. For example, mobile communication device 12 may include a portable device that communicates with an onboard device. A position or speed (and direction) of mobile communication device 12 may thus be indicative of a position or speed (and direction) of vehicle 18.

Infrastructure device 16 may include a device or sensor that is associated with an infrastructure that monitors or controls pedestrian or vehicle traffic. For example, infrastructure device 16 may include a traffic signal (e.g. a traffic light) for controlling pedestrian or vehicle traffic, a sensor system for monitoring a state of traffic (e.g. camera for imaging traffic conditions, an active or passive sensor system for monitoring a state of traffic, or an analysis system for analyzing acquired image or sensor data so as to determine a traffic condition).

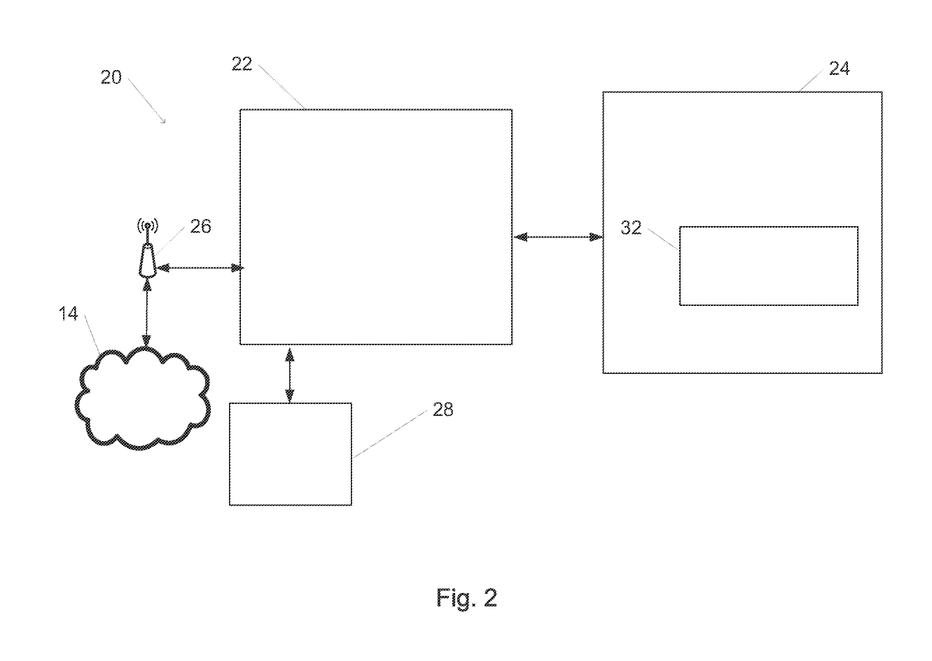

FIG. 2 schematically illustrates an embodiment of a server that is configured for use in accordance with embodiments of the present disclosure. Server 20 includes a processor 22. Processor 22 may include one or more devices with processing capability. For example, processor 22 may be incorporated into a computer, or a plurality of intercommunicating computers, that is associated with server 20. Some or all of the functionality of processor 22 may be distributed among remote computers or processors. Such a remote processor may include a processor of a mobile communication device 12 or an infrastructure device 16.

Processor 22 may operate in accordance with programmed instructions. Such programmed instructions may include instructions for an embodiment of a method for classification, position, and kinematic parameter measuring and reporting. Processor 22 may communicate with memory 28. Memory 28 may include one or more volatile or nonvolatile memory devices. Memory 28 may be utilized to store, for example, programmed instructions for operation of processor 22, data or parameters for use by processor 22 during operation, or results of operation of processor 22

Processor 22 may communicate with data storage device 24. Data storage device 24 may include one or more fixed or removable nonvolatile data storage devices. For example, data storage device 24 may include a computer readable medium for storing program instructions for operation of processor 22. In accordance with embodiments of the present disclosure, the programmed instructions may take the form of a communication scheme determination module 32 for determining a communication scheme for classification, position, and kinematic parameter measuring and reporting by one or more mobile communication devices 12.

It is noted that storage device 24 may be remote from processor 22. In such cases storage device 24 may be a storage device of a remote server storing communication scheme determination module 32 in the form of an installation package or packages that can be downloaded and installed for execution by processor 22. Data storage device 24 may be utilized to store data or parameters for use by processor 22 during operation, or results of operation of processor 22.

Processor 22 may communicate with one or more other devices via network connection 26. For example, network connection 26 may enable connection of processor 22 directly to a wireless network 14, and/or to a wire-based network 14. Connection of processor 22 to network 14 may enable processor 22 to communicate with one or more mobile communication devices 12, and/or with one or more infrastructure devices 16.

As noted above, server 20 may be provided as a cloud-based system. Server 20 receives classification, position, and kinematic parameter reports from relevant mobile devices. Server 20 then takes these position reports and aggregates them into a mosaic. Server 20 then, using the communications network, communicates the mosaic to a particular human-operated or autonomous vehicle, or to a fleet of such vehicles, that is/are at a particular location, or that is/are within a pre-defined geographical service area. The vehicle(s) then uses the all of the classification, position, and kinematic parameter information in the mosaic as another “sensor” for obstacle avoidance. For example, if the human-operated or autonomous vehicle receives information of a pedestrian headed towards the vehicle from a position that is not readily determinable by a vehicle sensor, the vehicle may use this information to change course, alter speed, or take other appropriate action to avoid conflict with the pedestrian. As such, the mosaic may include information regarding not only position of the mobile device, but also with regard to the type of obstacle (pedestrian, bicycle, vehicle, etc.) and the speed of movement of the obstacle as determined by successively received position reports over time. The vehicle may use this information in determining a course of action for obstacle avoidance.

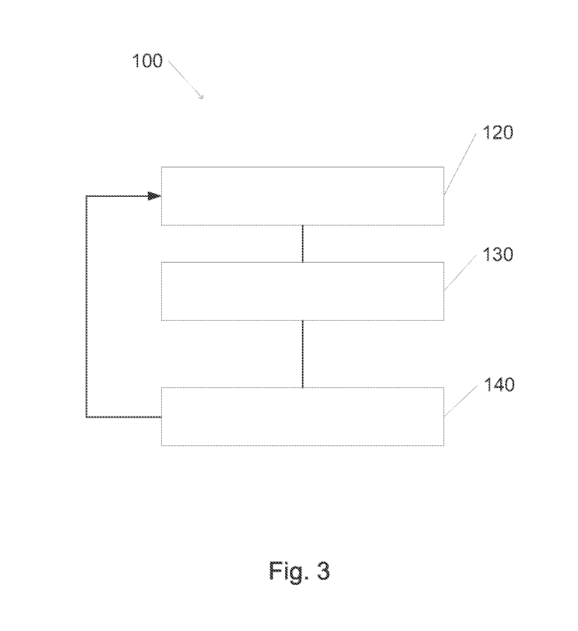

FIG. 3 is a flowchart for a method for classification, position, and kinematic parameter measuring and reporting in accordance with an embodiment of the present disclosure. Reporting method 100 may be executed by a processor of a server of a system for adaptive position reporting in accordance with an embodiment of the present disclosure. Reporting method 100 may be executed by a processor of a mobile communication device or of another device.

It should be understood with regard to flowcharts that are referenced herein that division of the illustrated method into discrete operations as represented by blocks of the flowchart has been selected for convenience and clarity only. Alternative division of the illustrated method into operations represented blocks is possible, with equivalent results. Any such alternative division into of the illustrated method into discrete operations should be understood as included within the scope of embodiments of the present disclosure.

It should also be understood with regard to flowcharts that are referenced herein that, unless indicated otherwise, the order of operations of the illustrated method as represented by ordering of blocks of the flowchart has been selected for convenience and clarity only. Operations of the illustrated method may be executed in a different order, or concurrently, with equivalent results. Any such alternative ordering of operations as represented by blocks should be understood as included within the scope of embodiments of the disclosure.

Reporting method 100 may be executed periodically, e.g. at predetermined intervals, or may be initiated in response to a sensed event. Execution of reporting method 100 may determine (as described below) when reporting method 100 is to be executed subsequently. Execution of reporting method 100 may be triggered by a sensed event, e.g. by a sensed change in reported position, by a sensed action by a vehicle (e.g. acceleration or braking of a vehicle as sensed by a sensor that communicates with an onboard computer of the vehicle and as reported to a processor that executes position reporting method 100), by a sensed change in traffic conditions (e.g. as reported by an infrastructure device), or by a sensed geographical position of interest, such as being near the location of a human-operated or autonomous vehicle or being within a geographic area that is serviced by a fleet of such vehicles. As used herein, the term near may mean within one mile, two miles, five miles, or ten mile, of the stated location.

Classification, position, and kinematic parameter data of a mobile communication device is obtained (block 120). Classification, position, and kinematic parameter data is received from various mobile devices. Classification data may associate a user with a form of travel or vehicle. Position data may include latitude/longitude coordinates. Position data may also include height above ground, which can be obtained using the aforementioned barometric sensor included on some mobile communication devices, in combination with digital maps that include elevation data. The height above ground data would allow for the filtering-out of non-street-level users, for example those who are in an office building or those who are not on the same street level where two or more streets are vertically stacked. Filtering-out may also occur for users not in the same area or on the same path as the vehicle. In some embodiments, reporting of position data may be initiated by the mobile communication device or may be requested by a server. Kinematic parameter data may be associated with direction, rate, or acceleration of movement. Data may be obtained for a classification, position, and kinematic parameter of the mobile communication device at two or more different times. Obtained position data may include geographic coordinates of the mobile communication device, or data from which geographical coordinates may be derived. Obtained data may include a speed or velocity (vector quantity) of the mobile communication device, or may include reporting position data at two or more reported times (or at known intervals) such that speed or velocity data may be derived.

Data may be obtained for a plurality of mobile communication devices. For example, the mobile communication devices may be located within a single geographical distance from one another. As another example, the mobile communication devices may be determined to be traveling along a common roadway or track, or may be traveling toward a common intersection.

A communication scheme may be determined on the basis of the obtained classification, position, and kinematic parameter data (block 130). A communication scheme may determine an interval between subsequent consecutive reports. For example, an interval between consecutive reports may be increased when a mobile device is at or near a particular location, or at or near a particular geographic service area. As used herein, the term near may mean within one mile, two miles, five miles, or ten mile, of the stated location. On the other hand, an interval between consecutive position reports may be fixed.

The device that is executing reporting method 100 may then cause the determined communication scheme to be implemented (block 140). The determined communication scheme may be implemented internally by the device that executes reporting method 100, or externally by another external device. If the communication scheme is to be executed externally, the communication scheme may be communicated to the external device. For example, one or more parameters (e.g. a reporting interval) that are associated with, or that define, the communication scheme may be communicated to the external device.

For example, in the case that reporting method 100 is being executed by a server, the communication scheme may be implemented internally by that server. The server 20 of FIG. 1 is one example thereof. On the other hand, the communication scheme may be implemented externally, e.g. by a processor of mobile communication device. The communication scheme, or one or more parameters of the communication scheme, e.g. a reporting interval, may be communicated to the mobile communication device. The mobile communication device may then implement the communication scheme.

As another example, reporting method 100 may be executed by a mobile communication device. The device 12 of FIG. 1 is one example thereof. The communication scheme may be implemented internally by that mobile communication device. On the other hand, the communication scheme may be implemented externally, e.g. by a processor of a server. The communication scheme, or one or more parameters of the communication scheme, e.g. a reporting interval, may be communicated to the server. The server may then implement the communication scheme, e.g. by requesting classification, position, and kinematic parameter measuring and reporting from a mobile communication device in accordance with the communicated communication scheme.

As noted above, the server 20 aggregates the classification, position, and kinematic parameter data received from a plurality of mobile devices, and provides that aggregated data as a digital mosaic map to a human-operated or autonomous vehicle for purposes of obstacle avoidance. In some autonomous embodiments, in view of the received mosaic map, the vehicle control system controls the input to for example automated steering, differential braking, automated braking, and/or other systems for obstacle avoidance. The control system may, for example, measure the relative location of objects with respect to the vehicle. If the relative distance between the host vehicle and an object is within a predefined distance and the relative velocity of the host vehicle with respect to the object or other reference is within a predefined value and/or range, a control system may determine that the object poses an obstacle to the vehicle. In response, the control system may output a command to a braking system to reduce the vehicle speed, output a steering angle command to an automated steering system, and/or perform other actions. In human-operated embodiments, the mosaic map may be provided as a digital display to the human operator.

Embodiments of the present disclosure may include apparatus for performing the operations described herein. Such apparatus may be specially constructed for the desired purposes, or may include computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the disclosure as described herein. Embodiments of the disclosure may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

While at least one exemplary classification, position, and kinematic parameter measuring and reporting system and method has been presented in the foregoing detailed description, it should be appreciated that a vast number of variations exist. It should also be appreciated that the exemplary classification, position, and kinematic parameter measuring and reporting system and method or exemplary reporting systems and methods are only examples, and are not intended to limit the scope, applicability, or configuration of the disclosure in any way. Rather, the foregoing detailed description will provide those skilled in the art with a convenient road map for implementing an exemplary classification, position, and kinematic parameter measuring and reporting system and method of the disclosure. It is understood that various changes may be made in the function and arrangement of elements described in an exemplary position reporting system and method without departing from the scope of the disclosure as set forth in the appended claims.

What is claimed is:

1. A method for road user classification, position, and kinematic parameter measuring and reporting comprising the steps of:
receiving, at a remotely located server, a digital, electronic report from a mobile device that comprises a user classification, a user geographical position, and at least one user kinetic parameter; and
providing the report, from the server, to a human-operated or autonomously-controlled vehicle,
wherein the steps of receiving and providing are performed automatically and without human intervention using a telecommunication network.

2. The method of claim 1, further comprising receiving, at the remotely located server, a plurality of digital, electronic reports from a plurality of mobile devices.

3. The method of claim 2, further comprising storing information at the server that at least one of the plurality of mobile devices is associated with a pedestrian, with a bicyclist, or with a vehicle.

4. The method of claim 2, further comprising filtering-out reports from the plurality of digital, electronic reports if the associated user is not in a same area, in a path, or on a same street level as the human-operated or autonomously-controlled vehicle.

5. The method of claim 2, wherein the geographical position comprises truncated global positioning coordinates.

6. The method of claim 2, wherein the remotely located server is a cloud-based server.

7. The method of claim 2, further comprising, at the remotely located server, generating a digital mosaic of the plurality of reports and providing the digital mosaic to the human-operated or autonomously-controlled vehicle.

8. The method of claim 1, further comprising, at the remotely located server, receiving a subsequent digital, electronic report from a mobile device, calculating an estimated speed of travel of the mobile device based on the digital, electronic report and the subsequent digital, electronic report, and providing the estimated speed of travel, from the server, to the autonomously-controlled vehicle.

9. The method of claim 1, further comprising providing the report, from the server, to a fleet of autonomously-controlled vehicles, all of which are located within a geographical service area.

10. The method of claim 1, wherein the telecommunication network is a 4G LTE telecommunication network.

11. The method of claim 1, wherein the mobile device is a smartphone, tablet computer, or computer system integrated within a vehicle.

12. The method of claim 1, wherein the step of receiving is performed on the basis of a request to send a report generated from a computer application that is resident on the mobile device.

13. The method of claim 1, wherein the report is provided from the server in a format suitable for use by a control system of the autonomously-controlled vehicle.

14. A computer-based server system comprising:
a data storage component; and
a processor,
wherein the data storage component comprises electronic instructions that causes the processor to:
receive a digital, electronic report that includes a user classification, a user geographical position, and at least one user kinetic parameter, from a mobile device; and
provide the geographical position report to a human-operated or autonomously-controlled vehicle,
wherein the receive and provide functionalities are processed automatically and without human intervention using a telecommunication network.

15. The computer-based server system of claim 14, wherein the computer-based server system is implemented as a cloud-based server system.

16. The computer-based server system of claim 14, wherein the data storage component comprises electronic instructions that causes the processor to: receive a plurality of digital, electronic reports from a plurality of mobile devices.

17. The computer-based server system of claim 16, wherein the data storage component comprises electronic instructions that causes the processor to: generate a digital mosaic of the plurality of reports and provide the digital mosaic to the human-operated or autonomously-controlled vehicle.

18. The computer-based server system of claim 16, wherein the data storage component comprises electronic instructions that causes the processor to: receive a subsequent digital, electronic report from a mobile device, calculate an estimated speed of travel of the mobile device based on the digital, electronic report and the subsequent digital, electronic report, and provide the estimated speed of travel, from the server, to the human-operated or autonomously-controlled vehicle.

19. An autonomously-controlled vehicle comprising:
an autonomous vehicle control system; and
a telecommunication receiving system operably coupled with the autonomous vehicle control system,
wherein the telecommunication receiving system is configured to receive, from a remotely-located server, a digital, electronic report that includes a user classification, a user geographical position, and at least one user kinetic parameter, which originated from a mobile device, and wherein, based on the report, the autonomous vehicle control system is configured to cause the autonomously-controlled vehicle to operate in a manner that avoids conflict with the mobile device.

20. The autonomously-controlled vehicle of claim 19, wherein the telecommunication receiving system is configured to receive, from the remotely located server, a digital mosaic of a plurality of reports originate from a plurality of mobile devices, and wherein, based on the digital mosaic, the autonomous vehicle control system is configured to cause the autonomously-controlled vehicle to operate in a manner that avoids conflict with each of the plurality of mobile devices.
